(19) United States
(12) Patent Application Publication
(10) Pub. No.: US 2026/0086287 A1
(43) Pub. Date: Mar. 26, 2026

(54) OPTICAL TERMINALS

(71) Applicant: RELATIVE DYNAMICS INCORPORATED, Laurel, MD (US)

(72) Inventor: Michael Krainak, Fulton, MD (US)

(21) Appl. No.: 19/181,884

(22) Filed: Apr. 17, 2025

Related U.S. Application Data
(60) Provisional application No. 63/635,966, filed on Apr. 18, 2024.

(51) Int. Cl. G02B 6/24; G02B 3/00; G02B 6/028; G02B 6/32

(52) U.S. Cl. CPC G02B 6/241; G02B 6/0288; G02B 6/32; G02B 3/0056

(57) ABSTRACT

Systems disclosed herein are directed to optical terminals configured for free space communication comprising at least one lens collector assembly comprising a lens and a dual clad fiber optic coupler attached to the at least one lens, and a transceiver operably connected to the at least one lens collector assembly.

### CROSS REFERENCE TO RELATED PATENT APPLICATIONS

This application claims the priority and benefit under 35 U.S.C. § 119(e) of U.S. Provisional Patent Application Ser. No. 63/635,966 filed Apr. 18, 2024, entitled “OPTICAL TERMINALS”. U.S. Provisional Patent Application Ser. No. 63/635,966 is herein incorporated by reference in its entirety.

### TECHNICAL FIELD

Embodiments are generally related to the field of transceivers. Embodiments are also related to optical transceivers. Embodiments are further related to communications systems. Embodiments are further related to methods and systems for high-bandwidth communications to and from aircraft, watercraft, vehicles, drones, autonomous vehicles, space vehicles, and the like. Embodiments are further related to an optical terminal for free-space communication.

### BACKGROUND

Current commercial communication technologies generally employ radio frequency (RF), a reliable and proven form of communication that is robust to most atmospheric effects. However, current RF systems, even when used with shaped antenna patterns, are a broadcast medium that suffers from signal decay and limitations in data rates. Existing systems may reach 1 Gbps, but a significant power requirement caps practical applications.

Another option is laser optical communication. Investigation of laser communication technology has been ongoing. In the 1980s, preliminary work determined the requirements for high-power lasers to provide communications capabilities. Preliminary demonstrations of space-based laser communication were performed via the Artemis spacecraft's SILEX system. Such demonstrations were technically significant, but practically limited by the significant mass and power requirements necessary even for limited data transmission.

In addition, at present there are limited optical assemblies suitable for a very small size (<inches) and low weight (<100 gram) free-space optical communications applications. There would be numerous applications for micro free-space optical transmitters and receivers including but not limited to UAV/drone, motor vehicle (automobile, truck), backpack, boat, ship, spacecraft, and robotics.

However, core-boresight alignment for a transmitter/receiver is difficult to achieve and maintain in the real word as a result of vibration, changes in temperature, pressure, etc. furthermore, the required optics to separate the transmitter and receiver signals may be complex.

While traditional optical systems could work in some circumstances, it is difficult to simultaneously provide a wide field-of-view and couple light efficiently into multi-mode and single mode fiber. In prior art approaches, this is solved with a mechanical mechanism, namely, a gimbal and/or a fast steering mirror (or both). Many such mechanisms are expensive, require high voltages, and high electrical power. In addition, these mechanisms only work over a narrow field-of-view at any time.

To achieve a wider field-of-view, a portion of the mechanism can be rotated. As a result, the mechanism can never achieve a simultaneous wide field-of-view. The mechanism approximates a “simultaneous” field-of-view” by moving very rapidly (kHz rates are required for some applications). This approach is even more difficult if the size of the required field-of-view is large.

Nevertheless, there is a need for small optical communication systems because they can operate at enormous data rates (Multiple terabits per second). In addition, free-space optical (FSO) (e.g. “laser”) communication is not regulated by the International Telecommunication Union or Federal Communications Commission and it can be used without restrictions and does not require costly licenses.

High-speed communication is a vital aspect of communication technology, and is critically important for modern applications such as drones. Therefore, there is a need in the art for advanced optical transceiver systems, as disclosed herein, that will help maximize the value of the next generation optical communication.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

The present embodiments relate to an optical terminal that provides a means to communicate using information impressed on an optical carrier that propagates in free space.

An aspect of the disclosed embodiments is optical communication.

Another aspect of the disclosed embodiments is laser communication.

An aspect of the disclosed embodiments is a miniature optical terminal for free-space optical communication.

As aspect of the disclosed embodiments is LIDAR based systems.

An aspect of the disclosed embodiments includes a “fly's eye” lens for facilitating optical free-space communication.

An aspect of the disclosed embodiments is a double-clad coupler associated with an optical transceiver.

Aspects of the disclosed embodiments, further include a passive optical system that simultaneously provides a wide field-of-view and couples the light efficiently into multimode or single-mode fiber.

For example, in an embodiment, an optical terminal comprises at least one lens collector assembly comprising a lens and a dual clad fiber optic coupler attached to the at least one lens, and a transceiver operably connected to the at least one lens collector assembly. In an embodiment, the dual clad fiber optic coupler further comprises a receive fiber optic cable and a transmit fiber optic cable. In an embodiment, the dual clad fiber optic coupler is configured to optically isolate the receive fiber optic cable and the transmit fiber optic cable. In an embodiment, the receive fiber optic cable in the dual clad fiber optic coupler comprises a multimode fiber optic cable. In an embodiment, the transmit fiber optic cable in the dual clad fiber optic coupler comprises a single-mode fiber optic cable. In an embodiment, the at least one lens collector assembly comprises a plurality of lens collector assemblies. In an embodiment, the optical terminal further comprises a fiber combiner configured to combine a receive fiber optic cable from each of the plurality of lens collector assemblies. In an embodiment, the optical terminal further comprises a fiber splitter configured to split a transmit fiber from the transceiver to each of the plurality of lens collector assemblies. In an embodiment, the optical terminal further comprises configuring the lens associated with each of the plurality of lens collector assemblies to point in a different direction. In an embodiment, the lens comprises an aspheric lens.

In an embodiment an optical “fly's eye” receiver comprises a lens array comprising a plurality of lenses, a fiber combiner configured to combine signals from the plurality of lenses, an optical transceiver, and a fiber optic cable connecting the fiber combiner to the optical transceiver. In an embodiment, the lens array comprises a monolithic lens array. In an embodiment, each lens in the lens array is hexagonal. In an embodiment, the optical receiver comprise configuring each of the plurality of lenses in the lens array to point in a different direction. In an embodiment, the fiber combiner further comprises a multi-mode fiber combiner.

In an embodiment, an “fly's eye” optical receiver comprises a lens array comprising a plurality of lenses in a single plane, a fiber combiner configured to combine signals from the plurality of lenses, an optical transceiver, and a fiber optic cable connecting the fiber combiner to the optical transceiver. In an embodiment, the lens array comprises a microlens array. In an embodiment, each lens in the lens array is in the same plane as every other lens in the lens array. In an embodiment, the optical receiver further comprises an optical element associated with each lens in the lens array, wherein the optical element is positioned at a different relative location to the optical axis of each lens in the lens array. In an embodiment, the fiber combiner further comprises a multi-mode fiber combiner.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of an optical transceiver system, in accordance with the disclosed embodiments;

FIG. 2 depicts aspects of a lens collector assembly associated with an optical transceiver system, in accordance with the disclosed embodiments;

FIG. 3 depicts aspects of a dual clad fiber coupler associated with an optical transceiver system, in accordance with the disclosed embodiments;

FIG. 4A depicts aspects of a fly's eye optical receiver system associated with an optical communication terminal, in accordance with the disclosed embodiments;

FIG. 4B depicts aspects of a fly's eye optical receiver system associated with an optical communication terminal, in accordance with the disclosed embodiments;

FIG. 5A depicts aspects of another fly's eye optical receiver system associated with an optical communication terminal, in accordance with the disclosed embodiments;

FIG. 5B depicts ray traces associated with a fly's eye optical receiver system associated with an optical communication terminal, in accordance with the disclosed embodiments;

FIG. 6A depicts aspects of another fly's eye optical receiver system associated with an optical communication terminal, in accordance with the disclosed embodiments;

FIG. 6B depicts ray traces associated with a fly's eye optical receiver system associated with an optical communication terminal, in accordance with the disclosed embodiments; and

FIG. 7 depicts aspects of an opto-mechanical system associated with an optical communication terminal, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

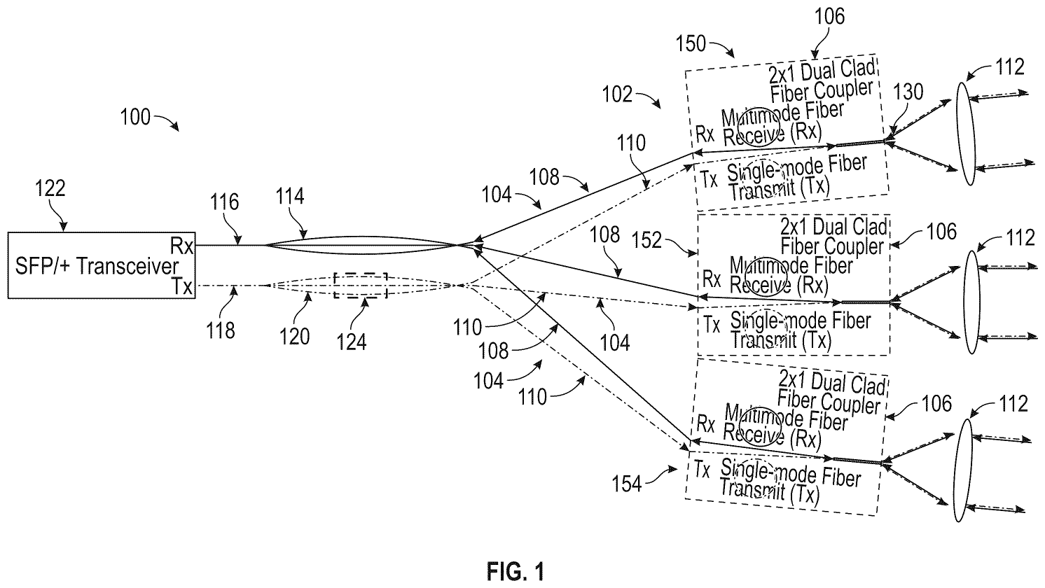

The embodiments disclosed herein are directed to systems and methods for transmitting data with optical transceivers. FIG. 1 illustrates an exemplary embodiment of a transceiver system 100.

The transceiver system 100 comprises a so-called “fly's eye” architecture, that can serve simultaneously as a transmitter and receiver. The fly's eye architecture can comprise a series of lens collector assemblies 102, such as for example, first lens collector assembly 150, second lens collector assembly 152, and third lens collector assembly 154, etc.

Each of the lens collector assemblies 102 can comprise a lens 112 connected to a fiber optic cable 104. The fiber optic cable 104 can be coupled to the lens 112 with a 2×1 dual clad fiber optic coupler 106. The coupler 106 is positioned at the focal point 130 of the lens. The light travels through free space from the lens to the coupler (i.e., when receiving) or from the coupler to the lens (when transmitting). More specifically, the dual clad fiber optic cable 104 can be connected to a multimode receive fiber optic cable 108 and a single mode transmit fiber optic cable 110 via the dual clad fiber optic coupler 106.

The dual clad-fiber coupler 106 provides monolithic integrated alignment of the transmit fiber 110 (which can comprise a single-mode fiber core), and the receive fiber 108 (which can comprise a multimode fiber outer core). The coupler 106 separates/isolates the transmit optical signal provided via the single-mode transmit fiber 110 (which is in the core of the coupler 106), from the receive optical signal provided via the multimode receive fiber 108 (which is exterior to the cladding and optically separated from the core). This allows the use of a single optical lens 112 (or mirror) to both collimate the transmit light in the outgoing direction, and collect the receive light into the multimode outer core.

The double-clad fiber coupler along with a single lens can be used to make an extremely small optical transceiver. An advantage is that the double-clad coupler 106, based optical terminal can be used at a wide range of optical wavelengths (visible through near-infrared).

The system can include multiple sets of lens collector assemblies 102, which creates the fly's eye architecture. The respective multimode receive fiber optic cables 108 from each of the lens collector assemblies 102 can be combined with a fiber combiner 114, into receive fiber 116. Likewise, the transmit fiber 118 can be split with fiber splitter 120 into the respective single mode transmit fiber optic cables 110 going to each of the lens collector assemblies 102.

This configuration allows the system to simultaneously look in multiple directions using incoherent (direct detection) multimode fiber beam combiners.

The system 100 further includes a transceiver 122. The transceiver 122 can comprise a small form factor pluggable (SFP) transceiver. The transceiver 122 can receive input from each of the lens collector assemblies 102 via the receive fiber 116. The transceiver 122 can further provide output to all of the respective lens collector assemblies 102 via the transmit fiber 118.

The disclosed transceiver 122 is configured to both transmit (Tx) and receive (Rx). The SFP transceiver 122 is “pluggable” meaning it can easily be replaced when faulty, or upgraded (to a higher data rate) when required. The system 100 thus makes use of the SFP transceiver 122 with the additional optical elements to allow multi-directional free-space optical communication.

It should be appreciated that in FIG. 1, three lens collector assemblies 102 are illustrated. However, in other embodiments more or fewer of these assemblies could be used, depending on design considerations. An advantage of the fly's eye architecture is that multiple lens and double-clad fiber assemblies can be used with each assembly pointing in a different direction. Likewise, the transmitter optical signals can have a common source that is split into multiple optical sources using the fiber splitter 120. The receiver optical signals are combined into a single fiber 116 using a fiber optic beam combiner 114, reducing the number of detectors required.

In an embodiment the optical signals from the lens collector assemblies 102 can be combined with the fiber combiner 114 for the transceiver 122, while the transmit optical signal is switched to one fiber/lens at a time with a fiber switch 124. In an exemplary embodiment, the fiber switch 124 can comprise a switch with a small form factor including size, weight, and power. In an embodiment, the fiber switch 124 comprises a micro electro-mechanical system (MEMS) switch. This allows the use of all the transmitter associated with the transceiver 122 optical power for a single direction once a second optical terminal is acquired at a long distance.

It should be understood that in certain embodiments, the transmitter and receiver wavelengths are different and optical filters (e.g., fiber grating narrowband optical filters) can be used to isolate the receiver optical signal from undesirable backscattered light from the transmitter optical signal.

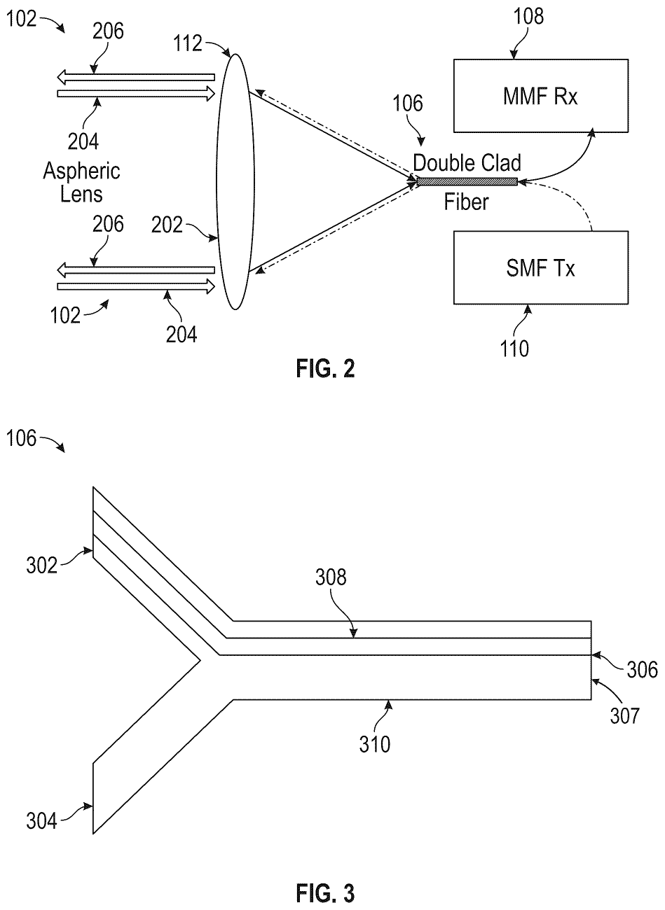

FIG. 2 illustrates exemplary aspects of any one of the lens collector assemblies 102. As illustrated, the lens 112 can comprise an aspheric lens 202 configured to receive or transmit optical signals. Input signals 204, and output signals 206 are illustrated. The lens 112 is operably connected to the double clad fiber 106, which in turn is connected to the multi-mode receive fiber 108 and the single mode transmit fiber 110.

FIG. 3 illustrates aspects of the dual clad fiber coupler 106. The double clad fiber 106 coupler 106 can comprise a first port 302 and a second port 304.

Single-mode light can be input first port 302 and transmits light to exit port 306. The double clad fiber coupler 106 has a single mode fiber core 308. Transmit signals from the transceiver are provided through the single mode fiber core 308. Collected light travels through the multimode inner cladding 310. Thus, the single mode transmit signal travels from input port 302 through the core 308 to be output at port 306. Multimode input signals are received at port 307 and via the multimode fiber 310 and is output at exit port 304. The respective fibers can each include a light blocking jacket, to prevent interference between the respective fibers.

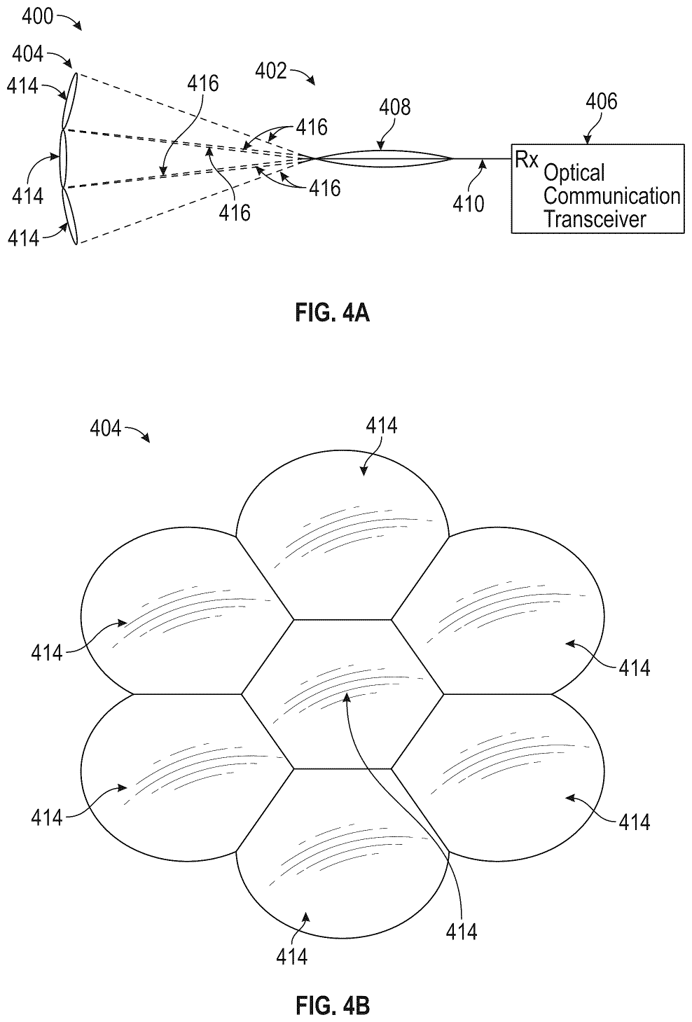

FIGS. 4A and 4B illustrate aspects of a system 400 making use of a fly's eye architecture associated with a receiver assembly 402. The system 400 can include a monolithic lens array 404 comprising multiple monolithic lenses. In the exemplary embodiment, illustrated in FIGS. 4A and 4B seven lenses are shown in the monolithic lens array 404, but it should be understood that in other embodiments a different number of lenses in the monolithic lens array can be used.

It should be noted that the system 400 can also be for transmission as well. the monolithic lens array 404 provides a noteworthy size advantage for the transmitter. But, for small terminals conserving electrical power is often a major concern. The monolithic lens array 404 improves the optical throughput (i.e. light gathering) efficiency. For a transmitter—sending the light simultaneously in multiple directions may help to reduce the time for locating and acquiring the distant terminal.

FIG. 4A illustrates a side view of the system 400 including a transceiver 406 configured to receive input and transmit output via fiber optic cable 410. The system 400 can include a multimode fiber combiner 408. Optical signals 416 from the lens array 404 can be combined into a single fiber 410 using the fiberoptic beam-combiner 408, which reduces the number of detectors required. The light from the lens array travels through free space with a fiber combiner input fiber at the focal point of each individual lens.

The monolithic lens array 404 can be close packed, with each of the monolithic lenses 414 in the monolithic lens array 404 being a hexagon, to reduce gaps between the lenses 414 arrangement for the lens elements, as shown in the front view of FIG. 4B. In an embodiment, each lens 414 in the monolithic lens array 404 can point in a different direction. In this way the “fly's eye” optical receiver system 400 with the monolithic array 404 is able to capture signals from a range of directions.

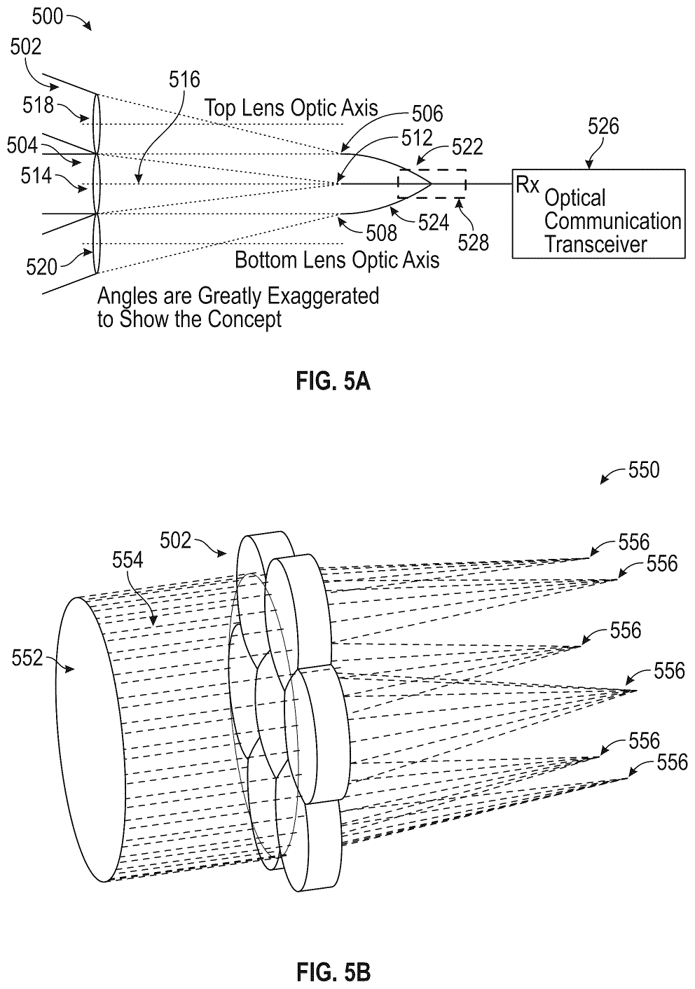

FIG. 5A illustrates another embodiment of a system 500 with a monolithic lens array 502 and a transceiver 526. In this embodiment, the monolithic lens array 502 comprises a group of microlenses 504. However, all the lenses in the monolithic lens array 502 are configured in a single flat plane, and are all pointing in the same direction. Fiber from each of the respective microlenses 504 are combined with fiber combiner 528, and then connected to the transceiver 526

The optical receiving direction of each lens 504 in the monolithic lens array 502 is achieved by placing fiber-optic element 506 (i.e. a fiber optic cable input/output) at a specific location in the focal plane 508 of the associated lenses. By varying the location of the fiber-optic element 506 as a function of the optical axis of the associated lens, the angle of the Tx or Rx optical signal can be designated to a specific direction. As above, the system can also be used as a transmitter.

For example, the optical fiber 512 is associated with the central lens 514 in the lens array 504. The focal point of the central lens 514 is at the focal point on the optic axis 516 and the optical fiber 512 is positioned at the optic axis 516. The surrounding elements (lens 518 and lens 520) have optical fibers (fiber 522 and fiber 524 respectively) placed slightly off-axis from the optic axis of the associated lens. This changes the direction the associated lens “points”, to achieve the desired field of view for the entire system 500.

FIG. 5B provides a ray trace 550 for the system 500 shown in FIG. 5A illustrating the optical path for input signals. As illustrated, the source 552 provides a signal 554. Each of the seven lenses lens in the lens array 502 will have a different focal point 556, and the fiber-combiner input-fiber lateral location in the focal-plane of the lens-array is selected in one-to-one correspondence with the desired angle of the Tx or Rx optical signal for each specific lens element in the lens array.

In an embodiment the fly's eye system illustrated in FIGS. 4A, 4B, 5A, or 5B is configured for incoherent (a.k.a., direct detection) multimode output. In this embodiment, the receiver optical signals are combined into a single multimode fiber using a fiber optic beam combiner. This allows the use of a single detector as opposed to an array of detectors. The multimode fiber combiner can use several multimode fibers with identical core diameters (e.g., 25 microns), that is smaller than the multimode output fiber, bundled and tapered into a combiner assembly with one multimode output fiber. The output multimode fiber has a core that is larger (e.g., 50 microns) than the set of identical input multimode fibers.

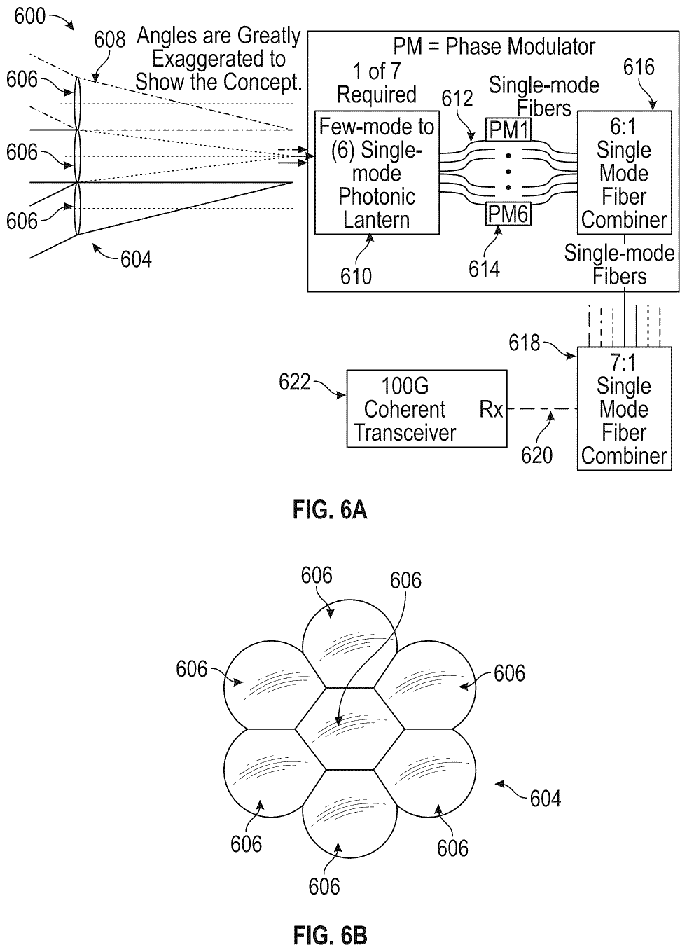

In another embodiment, the fly's eye system 600, illustrated in FIG. 6A, is configured for coherent single-mode-output. In this embodiment a back-end receiver is provided that can simultaneously look in multiple directions.

The system 600 includes a monolithic lens array 604 comprising a group of lenses 606. The exemplary embodiment in FIG. 6A shows six lenses but in other embodiments, other numbers of lenses can be used. The lens array 604 uses lens elements 606, where the outer lens elements 606 have their corresponding input fibers with lateral positions slightly off-axis in the direction of the central lens to maximize the overall angular field of view.

In this embodiment received light 608 enters the macro-lens array 604, and is focused into the few-mode input of a photonic-lantern 610 that has independent single-mode fiber outputs 612. The single-mode fiber outputs are coherently combined by using independent phase modulators 614, a first 6:1 single mode fiber combiner 616 and a second 7:1 single mode fiber combiner 618 to produce one single-mode fiber output 620 that is fed into a coherent receiver 622.

To maximize the throughput and eliminate the lens array vacant space, the lenses 606 are combined into a molded monolithic close-packed lens array 604 as illustrated in the front view provided in FIG. 6B.

It should be appreciated that only one channel of phase combiner is shown in FIG. 6A for simplicity. For the entire lens array (or seven lenses) 604 42 single-mode phase-combining is required. This can be accomplished with a photonic integrated circuit (not shown).

In such an embodiment, received light enters the macro-lens array and is focused into the few-mode input of a photonic-lantern that has independent single-mode fiber outputs. The single-mode fiber outputs are coherently combined by using independent phase modulators to produce one single-mode fiber output that is fed into a coherent receiver. To maximize the throughput and eliminate the lens array vacant space the lenses are combined into a molded monolithic close-packed lens array. The coherent single-mode-output optical fly's-eye receiver is used at the back end of each single telescope instead of the fast steering mirror (FSM). The fly's eye optical receiver may serve to replace a high size, weight, power, and cost (SWaP-C) FSM as lower SWaP-C passive component. The photonic-lantern single-mode fiber outputs are in a single fiber bundle that relays the received light to phase modulators and a coherent optical combiner that can be located off of the telescope gimbal. The phase modulators (as well as the photonic lantern) can be placed on a single photonic integrated circuit to greatly reduce the required phase modulator and combiner SWaP.

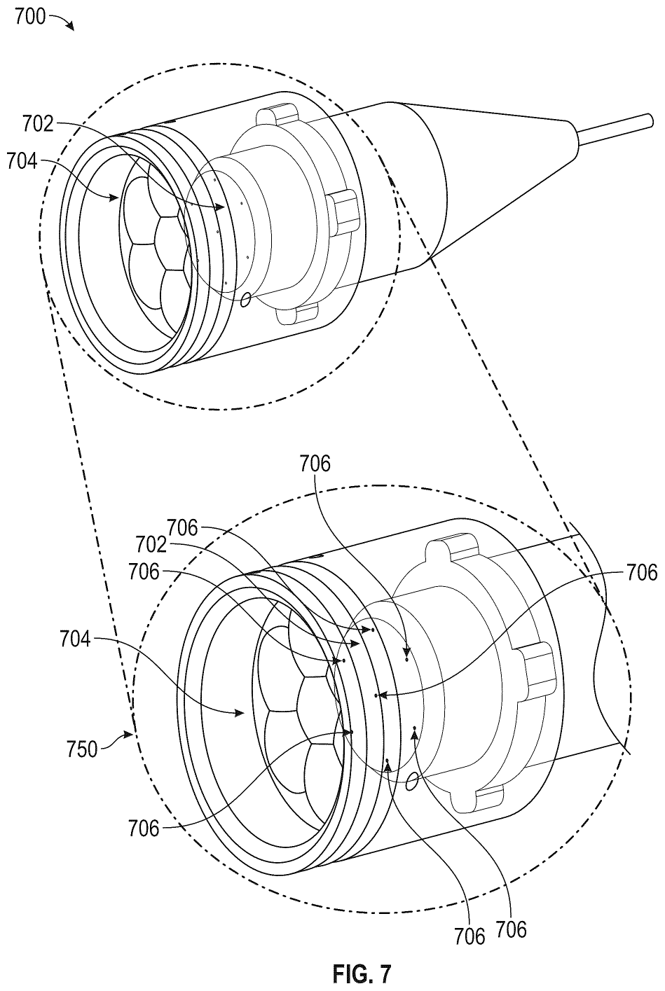

FIG. 7 illustrates an exemplary opto-mechanical assembly 700 that includes a lens array 704. The lens array 704 can comprise with either the multimode fiber combiner output system 400 or the multiple photonic lanterns outputs associated with system 500.

The opto-mechanical assembly 700 includes a micron-positioning precision-drilled plate 702. Aspects of the plate 702 are illustrated in exploded view 750. The plate 702 is precision drilled (e.g., laser drilled) with holes 706, which are drilled at the correct positions to receive light at a specified angular range. The angular range is consistent with the lens and the fiber numerical aperture. The holes 706 can be drilled with micron precision diameters to secure the multimode optical fibers or photonic lanterns.

While there are numerous ways in which the disclosed embodiments could be used, some exemplary applications include a free-space optical communication on a small UAV/drone. This allows an individual user-deployed equivalent “cell phone” tower without the need for unique real estate, licenses, or construction. Another unique example is the use on a boat in the middle of a lake or ocean. Applications can also include high-altitude-platforms (above the clouds) and orbiting satellites. In some embodiments, light emitting diodes can be used to communicate with robotic assemblies with the disclosed embodiments, particularly in indoor or factory environments. In other embodiments, the disclosed systems can be used with lidars, imaging systems, and spectrometers.

Various embodiments are disclosed herein. For example, in an embodiment, an optical terminal comprises at least one lens collector assembly comprising a lens and a dual clad fiber optic coupler attached to the at least one lens, and a transceiver operably connected to the at least one lens collector assembly. In an embodiment, the dual clad fiber optic coupler further comprises a receive fiber optic cable and a transmit fiber optic cable. In an embodiment, the dual clad fiber optic coupler is configured to optically isolate the receive fiber optic cable and the transmit fiber optic cable. In an embodiment, the receive fiber optic cable in the dual clad fiber optic coupler comprises a multimode fiber optic cable. In an embodiment, the transmit fiber optic cable in the dual clad fiber optic coupler comprises a single-mode fiber optic cable. In an embodiment, the at least one lens collector assembly comprises a plurality of lens collector assemblies. In an embodiment, the optical terminal further comprises a fiber combiner configured to combine a receive fiber optic cable from each of the plurality of lens collector assemblies. In an embodiment, the optical terminal further comprises a fiber splitter configured to split a transmit fiber from the transceiver to each of the plurality of lens collector assemblies. In an embodiment, the optical terminal further comprises configuring the lens associated with each of the plurality of lens collector assemblies to point in a different direction. In an embodiment, the lens comprises an aspheric lens.

In another embodiment, an optical receiver comprises a lens array comprising a plurality of lenses, a fiber combiner configured to combine signals from the plurality of lenses, an optical transceiver, and a fiber optic cable connecting the fiber combiner to the optical transceiver. In an embodiment, the lens array comprises a monolithic lens array. In an embodiment, each lens in the lens array is hexagonal. In an embodiment, the optical transceiver comprises configuring each of the plurality of lenses in the lens array to point in a different direction. In an embodiment, the fiber combiner further comprises a multi-mode fiber combiner.

In an embodiment, an optical receiver comprises a lens array comprising a plurality of lenses in a single plane, a fiber combiner configured to combine signals from the plurality of lenses, an optical transceiver, and a fiber optic cable connecting the fiber combiner to the optical transceiver. In an embodiment, the lens array comprises a microlens array. In an embodiment, each lens in the lens array is in the same plane as every other lens in the lens array. In an embodiment, the optical receiver further comprises an optical element associated with each lens in the lens array, wherein the optical element is positioned at a different relative location to the optical axis of each lens in the lens array. In an embodiment, the fiber combiner further comprises a multi-mode fiber combiner.

It should be appreciated that various presently unforeseen or unanticipated alternatives, modifications, variations, or improvements therein may be subsequently made by those skilled in the art which are also intended to be encompassed by the following claims.

What is claimed is:

1. An optical terminal comprising:
at least one lens collector assembly comprising:
a lens; and
a dual clad fiber optic coupler attached to the lens; and
a transceiver operably connected to the at least one lens collector assembly.

2. The optical terminal of claim 1 wherein the dual clad fiber optic coupler further comprises:
a receive fiber optic cable; and
a transmit fiber optic cable.

3. The optical terminal of claim 2 wherein the dual clad fiber optic coupler is configured to optically isolate the receive fiber optic cable and the transmit fiber optic cable.

4. The optical terminal of claim 2 wherein the receive fiber optic cable in the dual clad fiber optic coupler comprises:
a multimode fiber optic cable.

5. The optical terminal of claim 2 wherein the transmit fiber optic cable in the dual clad fiber optic coupler comprises:
a single-mode fiber optic cable.

6. The optical terminal of claim 1 wherein the at least one lens collector assembly comprises:
a plurality of lens collector assemblies.

7. The optical terminal of claim 6 further comprising:
a fiber combiner configured to combine a receive fiber optic cable from each of the plurality of lens collector assemblies.

8. The optical terminal of claim 6 further comprising:
a fiber splitter configured to split a transmit fiber from the transceiver to each of the plurality of lens collector assemblies.

9. The optical terminal of claim 6 further comprising:
configuring the lens associated with each of the plurality of lens collector assemblies to point in a different direction.

10. The optical terminal of claim 1 wherein the lens comprises an aspheric lens.

11. An optical receiver comprising:
a lens array comprising a plurality of lenses;
a fiber combiner configured to combine signals from the plurality of lenses;
an optical transceiver; and
a fiber optic cable connecting the fiber combiner to the optical transceiver.

12. The optical receiver of claim 11 wherein the lens array comprises:
a monolithic lens array.

13. The optical receiver of claim 11 wherein each lens in the lens array is hexagonal.

14. The optical receiver of claim 11 further comprising:
configuring each of the plurality of lenses in the lens array to point in a different direction.

15. The optical receiver of claim 11 wherein the fiber combiner further comprises:
a multi-mode fiber combiner.

16. An optical receiver comprising:
a lens array comprising a plurality of lenses in a single plane;
a fiber combiner configured to combine signals from the plurality of lenses;
an optical transceiver; and
a fiber optic cable connecting the fiber combiner to the optical transceiver.

17. The optical receiver of claim 16 wherein the lens array comprises:
a microlens array.

18. The optical receiver of claim 16 wherein each lens in the lens array is in the same plane as every other lens in the lens array.

19. The optical receiver of claim 16 further comprising:
an optical element associated with each lens in the lens array, wherein the optical element is positioned at a different relative location to an optical axis of each lens in the lens array.

20. The optical receiver of claim 16 wherein the fiber combiner further comprises:
a multi-mode fiber combiner.
